(19) United States
(12) Patent Application Publication
(10) Pub. No.: US 2019/0310565 A1
(43) Pub. Date: Oct. 10, 2019

(54) TONER FOR ELECTROSTATIC CHARGE IMAGE DEVELOPMENT

(71) Applicant: Konica Minolta, Inc., Tokyo (JP)

(72) Inventors: Yusuke TAKIGAURA, Tokyo (JP); Takanari Kayamori, Kawasaki-shi (JP); Kaori Fujino, Tokyo (JP); Ikuko Sakurada, Tokyo (JP)

(21) Appl. No.: 16/286,202

(22) Filed: Feb. 26, 2019

(30) Foreign Application Priority Data
Apr. 9, 2018 (JP) 2018-074889

(51) Int. Cl. G03G 9/097; G03G 9/08

(52) U.S. Cl. CPC G03G 9/09708; G03G 9/0819; G03G 9/0827

(57) ABSTRACT

A toner for electrostatic charge image development includes: a toner base particle containing a binder resin; and an external additive containing a strontium titanate fine particle, wherein the binder resin contains an amorphous resin and a crystalline polyester resin, in which the crystalline polyester resin is a polycondensate of an aliphatic dicarboxylic acid having from 6 to 14 carbon atoms and an aliphatic diol having from 6 to 14 carbon atoms, and the strontium titanate fine particle contains a strontium titanate fine particle (A) and a strontium titanate fine particle (B), in which a particle diameter R_{A} of a peak top in number particle size distribution of the strontium titanate fine particle (A) is smaller than a particle diameter R_{B} of a peak top in number particle size distribution of the strontium titanate fine particle (B).

The entire disclosure of Japanese patent Application No. 2018-074889, filed on Apr. 9, 2018, is incorporated herein by reference in its entirety.

### BACKGROUND

### Technological Field

The present invention relates to a toner for electrostatic charge image development.

### Description of the Related Art

In recent years, in electrophotographic image forming apparatuses, toner for electrostatic charge image development (hereinafter also simply referred to as the “toner” or “toner particles”) which is thermally fixed at a lower temperature is required in order to achieve further energy saving for the purpose of increasing the printing speed, diminishing the environmental burden, and the like. As a method for improving the low temperature fixability, toners have been proposed in which the melting temperature and melt viscosity of a binder resin are lowered and the low temperature fixability is improved by adding a crystalline material such as a crystalline polyester resin exhibiting sharp melting property as a fixing auxiliary to the binder resin. In the toners containing crystalline materials, it is considered that the low temperature fixability is improved as the plasticization of binder resin by crystalline materials proceeds. However, the heat resistance of binder resin deteriorates as the plasticization proceeds, and thus the aggregation of toner is likely to occur, for example, in a case in which the toner is stored in a developing machine in a state in which heat is applied thereto. Hence, it has been difficult to achieve both low temperature fixability and heat resistance (heat resistant storability) of toner.

As an attempt to achieve both low temperature fixability and heat resistant storability of toner, JP 2017-3916 A discloses a toner containing an amorphous polyester resin, a crystalline polyester resin, and a strontium titanate fine powder having a number average particle diameter of 30 nm or more and 300 nm or less.

The strontium titanate fine powder contained in the toner of JP 2017-3916 A is one kind of fine particles having a particle diameter of 30 nm or more and 300 nm or less. According to the investigation by the present inventors, strontium titanate fine particles having such a small particle diameter can suppress excessive electrification by covering the toner. However, when the coverage factor is too high, heat is less likely to be transmitted to the center of toner base particles at the time of fixing and the low temperature fixability deteriorates in some cases.

### SUMMARY

An object of the present invention is to provide a toner for electrostatic charge image development which exhibits both low temperature fixability and heat resistance and of which excessive electrification is suppressed.

To achieve the abovementioned object, according to an aspect of the present invention, a toner for electrostatic charge image development reflecting one aspect of the present invention comprises: a toner base particle containing a binder resin; and an external additive containing a strontium titanate fine particle, wherein the binder resin contains an amorphous resin and a crystalline polyester resin, in which the crystalline polyester resin is a polycondensate of an aliphatic dicarboxylic acid having from 6 to 14 carbon atoms and an aliphatic diol having from 6 to 14 carbon atoms, and the strontium titanate fine particle contains a strontium titanate fine particle (A) and a strontium titanate fine particle (B), in which a particle diameter R_{A} of a peak top in number particle size distribution of the strontium titanate fine particle (A) is smaller than a particle diameter R_{B} of a peak top in number particle size distribution of the strontium titanate fine particle (B).

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram of an apparatus used for measuring an electrically charged amount of a developer in Examples of the present application.

### DETAILED DESCRIPTION OF EMBODIMENTS

Hereinafter, one or more embodiments of the present invention will be described with reference to the drawings. However, the scope of the invention is not limited to the disclosed embodiments.

The toner of the present invention contains toner base particles containing an amorphous resin and a crystalline polyester resin as a binder resin and an external additive containing strontium titanate fine particles. In the present invention, it is possible to suppress excessive electrification of the toner while achieving both low temperature fixability and heat resistance by combining a specific crystalline polyester resin with at least two kinds of strontium titanate fine particles having different particle diameters of the peak tops in the number particle size distribution (strontium titanate fine particles (A) having a smaller particle diameter and strontium titanate fine particles (B) having a larger particle diameter). The mechanism thereof is not clear, but it is presumed as follows.

As a crystalline polyester resin is contained in the binder resin of the toner particles, the melting temperature and melt viscosity of the binder resin can be lowered and the low temperature fixability of the toner particles can be improved. Incidentally, as the numbers of carbon atoms in the acid and alcohol constituting the crystalline polyester resin are smaller, the crystalline polyester resin is more likely to melt, and thus the low temperature fixability of the toner is improved but the heat resistance thereof deteriorates. Hence, in the present invention, the crystalline polyester resin is a polycondensate of an aliphatic dicarboxylic acid having from 6 to 14 carbon atoms and an aliphatic diol having from 6 to 14 carbon atoms in order to maintain a balance between the low temperature fixability and the heat resistance. However, the specific crystalline polyester resin described above exhibits low polarity since the ester group concentration per polymer molecule is relatively low therein. For this reason, the toner containing the crystalline polyester resin described above exhibits low water absorbability and is likely to undergo excessive electrification particularly in a low temperature and low humidity environment.

In order to suppress such excessive electrification of the toner, fine particles of strontium titanate of being positively chargeable are used as an external additive. Strontium titanate is highly positively chargeable, and thus excessive electrification of the toner can be suppressed using a smaller number of particles as compared with the case of adding other particles. In order to sufficiently exert the effect of decreasing the electrically charged amount of the toner, it is required that the strontium titanate particles are not desorbed from the surface of the toner base particles but are retained thereon. Hence, it is desirable that the particle diameter of the strontium titanate particles is a smaller particle diameter so that the strontium titanate particles are more hardly desorbed from the surface of the toner base particles from the viewpoint of suppressing excessive electrification. However, the coverage factor of the surface of the toner base particles by the external additive is too high when the strontium titanate particles to be added all have a small particle diameter, thus heat is less likely to be transmitted to the center of the toner particles at the time of fixing and the low temperature fixability deteriorates in some cases. For this reason, in the present invention, at least two kinds of particles of the strontium titanate fine particles (A) (fine particles with smaller particle diameter) and strontium titanate fine particles (B) (fine particles with larger particle diameter) having different particle diameters of the peak tops in the number particle size distribution are concurrently used to cover the toner base particles. The strontium titanate fine particles (B) having a larger particle diameter are more likely to be desorbed from the toner base particles than the strontium titanate fine particles (A) having a smaller particle diameter, and thus the coverage factor by the strontium titanate fine particles tends to decrease as compared with a case in which the strontium titanate fine particles (A) having a smaller particle diameter are used singly. As a result, it is considered that the contribution of strontium titanate fine particles to low temperature fixability is also diminished.

Consequently, in the present invention, it is possible to provide a toner for electrostatic charge image development which exhibits both low temperature fixability and heat resistance and of which excessive electrification is suppressed by concurrently using a specific crystalline polyester resin with at least two kinds of strontium titanate fine particles having different particle diameters of the peak tops in the number particle size distribution.

The toner according to the present embodiment contains toner base particles containing at least a binder resin and an external additive containing strontium titanate fine particles. The toner base particles mainly contain a binder resin and are particles containing various additives such as a colorant, a release agent, a charge controlling agent, and a surfactant if necessary. First, the binder resin will be described.

1. Binder Resin (Crystalline Polyester Resin and Amorphous Resin)

The binder resin contains a crystalline polyester resin and an amorphous resin. In the present specification, the phrase “the binder resin contains a crystalline resin” may be an aspect in which the binder resin contains a crystalline resin itself or may be an aspect in which the binder resin contains a segment contained in another resin. In addition, in the present specification, the phrase “the binder resin contains an amorphous resin” may be an aspect in which the binder resin contains an amorphous resin itself or may be an aspect in which the binder resin contains a segment contained in another resin.

(Crystalline Polyester Resin)

The crystalline polyester resin refers to a polyester resin which does not have a stepwise endothermic change but has a distinct endothermic peak in the differential scanning calorimetry (DSC) measurement of the toner.

Specifically, the distinct endothermic peak means a peak having a full width at half maximum of an endothermic peak of 15° C. or less in DSC when the toner is measured at a rate of temperature rise of 10° C./min. It is preferable that the content of such a crystalline resin is in a range of from 3% to 30% by mass with respect to the mass of the toner. This makes it possible to improve the sharp melting property of the binder resin and to suppress deterioration in the heat resistance caused by containing a crystalline resin while obtaining the effect of improving the low temperature fixability of the toner.

The crystalline polyester resin to be used in the present invention is a polycondensate of an aliphatic dicarboxylic acid having from 6 to 14 carbon atoms and an aliphatic diol having from 6 to 14 carbon atoms. When the numbers of carbon atoms in the aliphatic dicarboxylic acid and aliphatic diol constituting the crystalline polyester resin are both in the above ranges, it is easy to suppress excessive electrification while achieving both low temperature fixability and heat resistance.

Examples of the aliphatic dicarboxylic acid having from 6 to 14 carbon atoms may include saturated aliphatic dicarboxylic acids such as adipic acid, sebacic acid, dodecanedioic acid, and tetradecanedioic acid; cycloaliphatic dicarboxylic acids such as cyclohexanedicarboxylic acid; aromatic dicarboxylic acids such as phthalic acid, isophthalic acid, and terephthalic acid; tri- or higher polycarboxylic acids such as trimellitic acid and pyromellitic acid; anhydrides thereof; and lower alkyl esters thereof.

Examples of the aliphatic diol having from 6 to 14 carbon atoms may include 1,6-hexanediol, 1,7-heptanediol, 1,8-octanediol, 1,9-nonanediol, 1,14-tetradecanediol, triethylene glycol, dipropylene glycol, hexamethylene glycol, octamethylene glycol, nonamethylene glycol, and decamethylene glycol.

The method for producing the crystalline polyester resin is not particularly limited, and the crystalline polyester resin can be produced by polycondensing (esterifying) the aliphatic dicarboxylic acid and the aliphatic diol using a known esterification catalyst.

Examples of the catalyst usable in the production of the crystalline polyester resin may include an alkali metal compound, a compound containing a Group 2 element, a metal compound, a phosphorous acid compound, a phosphoric acid compound, and an amine compound, and these may be used singly or in combination of two or more kinds thereof.

The reaction conditions for the polycondensation (esterification) reaction are not particularly limited, but the polycondensation (esterification) reaction can be conducted, for example, at from 150° C. to 250° C. for from 0.5 to 15 hours. In addition, the internal pressure of the reaction system may be reduced.

The melting point Tm of the crystalline polyester resin according to the present embodiment is preferably in a range of from 50° C. to 90° C. and more preferably in a range of from 60° C. to 80° C. from the viewpoint of achieving sufficient low temperature fixability and heat resistant storability.

The melting point Tm of the crystalline polyester resin can be measured by DSC. Specifically, a sample of the crystalline polyester resin is enclosed in an aluminum pan KITNO. B0143013, the pan is set in the sample holder of a thermal analysis instrument Diamond DSC (manufactured by PerkinElmer Inc.), and the temperature is changed by heating, cooling, and heating in this order. At the time of the first heating and second heating, the temperature is raised from room temperature (25° C.) to 150° C. at a rate of temperature rise of 10° C./min and held at 150° C. for 5 minutes. At the time of cooling, the temperature is lowered from 150° C. to 0° C. at a rate of temperature fall of 10° C./min and the temperature of 0° C. is held for 5 minutes. The temperature at the peak top of the endothermic peak in the endothermic curve attained at the time of second heating is measured as the melting point (Tm).

In the present invention, one kind or more kinds of the crystalline polyester resins may be used.

It is preferable that the content of the crystalline polyester resin in the binder resin is from 5% to 50% by mass. When the content of the crystalline polyester resin in the binder resin is less than 5% by mass, there is a possibility that the effect of retaining the external additive to be described later on the toner base particles is not obtained. On the other hand, when the content of the crystalline polyester resin in the binder resin is more than 50% by mass, there is a possibility that the coloring power and fixing performance of the toner deteriorate.

[Amorphous Resin]

The amorphous resin contained in the toner of the present invention constitutes the binder resin together with the crystalline resin. The amorphous resin is a resin which does not have a melting point but has a relatively high glass transition temperature (Tg) when being subjected to the differential scanning calorimetry (DSC) measurement.

In the DSC measurement, when the glass transition temperature in the first heating process is taken as Tg₁ and the glass transition temperature in the second heating process is taken as Tg₂, Tg₁ of the amorphous resin is preferably 35° C. or more and 80° C. or less and particularly preferably 45° C. or more and 65° C. or less from the viewpoint of reliably achieving fixability such as low temperature fixability and heat resistance such as heat resistant storability. In addition, Tg₂ of the amorphous resin is preferably 20° C. or more and 70° C. or less and particularly preferably 30° C. or more and 55° C. or less from the same viewpoint as the above.

The content of the amorphous resin is not particularly limited but is preferably 20% by mass or more and 99% by mass or less with respect to the entire amount of the toner base particles from the viewpoint of image strength. Furthermore, the content of the amorphous resin is more preferably 30% by mass or more and 95% by mass or less and particularly preferably 40% by mass or more and 90% by mass or less with respect to the entire amount of the toner base particles. Incidentally, in a case in which two or more kinds of resins are contained as the amorphous resin, the total amount of these resins is preferably in the above content range with respect to the entire amount of the toner host particles. Incidentally, in a case in which an amorphous resin containing a release agent is used as well, the content of the release agent in the amorphous resin containing a release agent is included in the content of the release agent constituting the toner.

The amorphous resin to be used in the toner base particles according to the present invention is not particularly limited, and amorphous resins conventionally known in the technical field can be used. Specific examples thereof may include a styrene-based resin, a vinyl-based resin, an olefin-based resin, an epoxy resin, a polyester resin, a polyurethane resin, a polyamide resin, a cellulose resin, and a polyether resin. These resins may be used singly or two or more kinds thereof may be used concurrently.

As the amorphous resin, a polyester resin and a vinyl-based resin are preferable and a polyester resin is particularly preferable.

The amorphous polyester resin is obtained by a polycondensation reaction of a di- or higher polycarboxylic acid (polycarboxylic acid) with a dihydric or higher polyhydric alcohol (polyhydric alcohol). Examples of the polycarboxylic acid and polyhydric alcohol to be used in the preparation of the amorphous polyester resin are not particularly limited. For example, as the polycarboxylic acid, it is preferable to use unsaturated aliphatic polycarboxylic acid, aromatic polycarboxylic acid, and any derivative thereof. A saturated aliphatic polycarboxylic acid may be concurrently used as long as an amorphous resin can be formed. In addition, the polycarboxylic acid may be used singly or in mixture of two or more kinds thereof.

As the polyhydric alcohol, it is preferable to use an unsaturated aliphatic polyhydric alcohol, an aromatic polyhydric alcohol, and any derivative thereof from the viewpoint of electrically charged property and toner strength. A saturated aliphatic polyhydric alcohol may be concurrently used as long as an amorphous resin can be formed. The polyhydric alcohols may be used singly or in mixture of two or more kinds thereof.

The method for producing the amorphous polyester resin is not particularly limited, and the resin can be produced by polycondensing (esterifying) the polycarboxylic acid and the polyhydric alcohol using a known esterification catalyst. The reaction catalyst and the reaction conditions are equivalent to the reaction conditions usable for the production of the crystalline polyester resin described above.

Hereinabove, the amorphous polyester resin has been described as a preferable form of the amorphous resin, but a vinyl-based resin and the like can be concurrently used as the amorphous resin.

<Other Constituent Components (Internal Additive)>

The toner base particles to be used in the present invention may contain internal additives such as a colorant, a release agent (wax), and a charge controlling agent in addition to the binder resin containing a crystalline resin and an amorphous resin.

<Colorant>

As the colorant to be contained in the toner of the present invention, known inorganic or organic colorants can be used. As the colorant, various kinds of organic or inorganic pigments, dyes and the like can be used in addition to carbon black and a magnetic powder.

As a yellow colorant for yellow toner, C.I. Solvent Yellow 19, 44, 77, 79, 81, 82, 93, 98, 103, 104, 112, 162, and the like can be used as a dye, C.I. Pigment Yellow 14, 17, 74, 93, 94, 138, 155, 180, 185, and the like can be used as a pigment, and any mixture of these can also be used.

As a magenta colorant for magenta toner, C.I. Solvent Red 1, 49, 52, 58, 63, 111, 122, and the like can be used as a dye, C.I. Pigment Red 5, 48:1, 53:1, 57:1, 122, 139, 144, 149, 166, 177, 178, 222, and the like can be used as a pigment, and any mixture of these can also be used.

As a cyan colorant for cyan toner, C.I. Solvent Blue 25, 36, 60, 70, 93, 95, and the like can be used as a dye and C.I. Pigment Blue 1, 7, 15:3, 18:3, 60, 62, 66, 76, and the like can be used as a pigment.

As a green colorant for green toner, C.I. Solvent Green 3, 5, 28, and the like can be used as a dye and C.I. Pigment Green 7 and the like can be used as a pigment.

As an orange colorant for orange toner, C.I. Solvent Orange 63, 68, 71, 72, 78, and the like can be used as a dye and C.I. Pigment Orange 16, 36, 43, 51, 55, 59, 61, 71, and the like can be used as a pigment.

As a colorant for black toner, carbon black, a magnetic material, iron-titanium composite oxide black, and the like can be used. As carbon black, channel black, furnace black, acetylene black, thermal black, lamp black, and the like can be used. In addition, as the magnetic material, ferrite, magnetite, and the like can be used.

The content ratio of the colorant is preferably 0.5% by mass or more and 20% by mass or less and more preferably 2% by mass or more and 10% by mass or less with respect to the entire mass of the toner. The color reproducibility of the image can be secured when the content ratio of the colorant is in such a range.

In addition, the size of the colorant is preferably 10 nm or more and 1000 nm or less, more preferably 50 nm or more and 500 nm or less, and particularly preferably 80 nm or more and 300 nm or less as a volume average particle diameter (volume median diameter). The volume average particle diameter may be a catalog value. In addition, for example, the volume average particle diameter (volume median diameter) of the colorant can be measured using “UPA-150” (manufactured by MicrotracBell Corp.).

<Release Agent>

A release agent can be added to the toner according to the present invention. Examples of the release agent may include dialkyl ketone-based waxes such as polyethylene wax, paraffin wax, microcrystalline wax, Fischer-Tropsch wax, and distearyl ketone, ester-based waxes such as carnauba wax, montan wax, behenyl behenate, behenate behenic acid, trimethylolpropane tribehenate, pentaerythrityl tetramyristate, pentaerythrityl tetrastearate, pentaerythrityl tetrabehenate, pentaerythrityl diacetate dibehenate, glycerin tribehenate, 1,18-octadecanediol distearate, tristearyl trimellitate, and distearyl maleate, and amide-based waxes such as ethylenediamine dibehenylamide and trimellitic acid tristearyl amide. These can be used singly or in combination of two or more kinds thereof.

The content ratio of the release agent in the toner is preferably 2% by mass or more and 30% by mass or less and more preferably 5% by mass or more and 20% by mass or less with respect to the entire mass of the toner.

<Charge Controlling Agent>

In addition, a charge controlling agent can be added (internally added) to the toner according to the present invention if necessary. As the charge controlling agent, various known ones can be used.

As the charge controlling agent, various known compounds which can be dispersed in an aqueous medium can be used, and specific examples thereof may include a nigrosine-based dye, a metal salt of naphthenic acid or a higher fatty acid, an alkoxylated amine, a quaternary ammonium salt compound, an azo-based metal complex, and a metal salt or metal complex of salicylic acid.

The content ratio of the charge controlling agent is preferably 0.1% by mass or more and 10% by mass or less and more preferably 0.5% by mass or more and 5% by mass or less with respect to the entire amount of the binder resin.

[Structure of Toner Base Particle]

The structure of the toner base particles according to the present embodiment may be a single layer structure formed only by the toner base particles described above or a multilayer structure such as a core-shell structure equipped with the toner base particles described above as core particles and a shell layer covering the core particles and the surface thereof. The shell layer may not cover the entire surface of the core particle, and the core particle may be partially exposed. The cross section of the core-shell structure can be confirmed by known observation means such as a transmission electron microscope (TEM) and a scanning probe microscope (SPM).

In the case of a core-shell structure, the properties such as the glass transition point, melting point, and hardness of the core particles can be different from those of the shell layer, and it is possible to design toner base particles depending on the purpose. For example, the shell layer can be formed by aggregating and fusing a resin having a relatively high glass transition point on the surface of a core particle which contains a binder resin, a colorant, a release agent and the like and has a relatively low glass transition point. As the shell layer, an amorphous polyester resin can be used as described above and an amorphous polyester resin modified with a styrene-acrylic resin can be preferably used among the amorphous polyester resins.

2. External Additive

The toner according to the present invention contains an external additive containing strontium titanate fine particles. The strontium titanate fine particles contains strontium titanate fine particles (A) and strontium titanate fine particles (B), and the a particle diameter R_{A} of the peak top in the number particle size distribution of the strontium titanate fine particles (A) is smaller than the particle diameter R_{B} of the peak top in the number particle size distribution of the strontium titanate fine particles (B). In the present invention, it is indispensable to concurrently use the strontium titanate fine particles (A) having a smaller particle diameter with the strontium titanate fine particles (B) having a larger particle diameter. The strontium titanate fine particles tend to be more easily desorbed from the toner base particles as the particle diameter thereof is larger. Hence, when at least two kinds of strontium titanate fine particles having a smaller particle diameter and a larger particle diameter are contained in the external additive, the coverage factor tends to decrease by the desorption of fine particles having a larger particle diameter as compared with a case in which the strontium titanate fine particles having a smaller particle diameter are used singly. Moreover, it is possible to prevent deterioration in the low temperature fixability while suppressing excessive electrification by strontium titanate fine particles by setting the coverage factor by the strontium titanate fine particles to a proper range.

From the viewpoint of achieving the effect by concurrent use of strontium titanate fine particles having a smaller particle diameter with the strontium titanate fine particles having a larger particle diameter described above, it is preferable that the particle diameter R_{A} of the strontium titanate fine particles (A) and the particle diameter R_{B} of the strontium titanate fine particles (B) satisfy the relation of the following Formula (1).

200 nm≤(R_{B}−R_{A})≤3000 nm Formula (1):

When the difference R_{B}− R_{A} in particle diameter between the strontium titanate fine particles (A) and (B) is 200 nm or more and 3000 nm or less, the strontium titanate fine particles (B) can be mainly desorbed from the toner base particles after the toner base particles have been temporarily covered with the strontium titanate fine particles (A) and (B). Hence, it is possible to suppress the influence of the covering of the toner base particles with the strontium titanate fine particles on the low temperature fixability. In addition, when the particle diameter R_{B} of the strontium titanate fine particles (B) is large so that the difference R_{B}−R_{A} in particle diameter between the strontium titanate fine particles (A) and (B) is more than 3000 nm, it is difficult for the strontium titanate fine particles (B) to cover the toner base particles together with the strontium titanate fine particles (A).

The particle diameter R_{A} of the strontium titanate fine particles (A) is preferably 10 nm or more and 100 nm or less and more preferably 20 nm or more and 60 nm or less. The low temperature fixability of the toner hardly deteriorates when the particle diameter R_{A} of the strontium titanate fine particles (A) is 10 nm or more, and the toner base particles can be covered at a high coverage factor and excessive electrification can be suppressed when the particle diameter R_{A} is 100 nm or less.

The particle diameter R_{B} of the strontium titanate fine particles (B) is preferably more than 300 nm and 2000 nm or less and more preferably 310 nm or more and 1500 nm or less. When the particle diameter R_{B} of the strontium titanate fine particles (B) is more than 300 nm, the strontium titanate fine particles (B) are relatively easily desorbed and it is thus easy to adjust the coverage factor by the strontium titanate fine particles so that the low temperature fixability hardly deteriorates. In addition, excessive electrification can be suppressed when the particle diameter R_{B} is 2000 nm or less.

In the present invention, the method for measuring the particle diameter of the strontium titanate fine particles varies depending on the shape of the particles.

The particle diameter of strontium titanate particles having a cubic or rectangular parallelepiped shape can be measured by the following method.

The eternal additives on the surface of toner particles are observed at a magnification of 40,000-fold under a scanning electron microscope (SEM) (for example, “JSM-7401F” manufactured by JEOL Ltd.). The longest diameter and shortest diameter of every particle are measured by image analysis of primary particles of the external additives, and the intermediate value thereof is taken as the sphere equivalent diameter. Thereafter, the number particle size distribution is determined based on the particle diameter and number of the 100 primary particles measured. The largest two peaks are selected among the peaks present in the distribution, one having a smaller peak value is taken as the peak of the strontium titanate fine particles (A) and the other having a larger peak value is taken as the peak of the strontium titanate fine particles (B), and the particle diameters of the peak tops of the peaks are taken as the particle diameters of the strontium titanate particles.

The peak top particle diameter of strontium titanate particles having an irregular shape can be measured by the following method.

Image photographing of the toner is conducted at a magnification of 5000-fold using a scanning electron microscope (SEM). Subsequently, energy dispersive X-ray analysis (EDS analysis) is conducted in this field of vision. At that time, the elemental analysis of strontium and titanium is conducted to identify strontium titanate particles. The SEM image in which strontium titanate has been identified is binarized using an image processing analyzer (for example, “LUZEX AP” manufactured by NIRECO CORPORATION). Among a plurality of photographs, the Feret diameters of 100 strontium titanate particles along the horizontal direction are calculated, and the particle size distribution is determined based on the Feret diameters along the horizontal direction and number of 100 strontium titanate particles. The largest two peaks are selected among the peaks present in the distribution, one having a smaller peak value is taken as the peak of the strontium titanate fine particles (A) and the other having a larger peak value is taken as the peak of the strontium titanate fine particles (B), and the Feret diameters along the horizontal direction of the peak tops of the peaks are taken as the particle diameters of the strontium titanate particles. Here, the Feret diameter along the horizontal direction is taken as the length of the side parallel to the x axis of the bounding rectangle when the image of the external additive is binarized.

Incidentally, the particle diameter of primary particles forming the aggregate is measured in a case in which the number average primary particle diameter of strontium titanate is small and the strontium titanate particles are present on the toner surface as an aggregate.

In addition, in an aspect in which the particle diameter R_{A} of the strontium titanate fine particles (A) is 100 nm or less, the particle diameter R_{B} of the strontium titanate fine particles (B) is more than 300 nm, and further other strontium titanate fine particles as to be described later are not contained, particles having a particle diameter of less than 200 nm can be defined as the strontium titanate fine particles (A) and particles having a particle diameter of 200 nm or more can be defined as the strontium titanate fine particles (B) among the 100 primary particles subjected to the measurement of particle diameter as described above, and the number average particle diameters which are the average values of the strontium titanate fine particles (A) and the strontium titanate fine particles (B) can also be respectively used instead of the particle diameters R_{A} and R_{B} which are the peak top particle diameters.

The shapes of the strontium titanate fine particles (A) and strontium titanate fine particles (B) to be used in the present invention are not limited and may be any of a cubic shape, a rectangular parallelepiped shape, or an irregular shape. However, it is preferable that either of the strontium titanate fine particles (A) or the strontium titanate fine particles (B) has a cubic shape and/or a rectangular parallelepiped shape. When the particle shape of one of the strontium titanate fine particles (A) or the strontium titanate fine particles (B) is a cubic shape and/or a rectangular parallelepiped shape and the particle shape of the other is an irregular shape, the contact area between the strontium titanate fine particles and the toner base particles increases, thus desorption of the strontium titanate fine particles from the toner base particles is suppressed, and the effect of decreasing the electrically charged amount is more likely to be exerted.

The shapes of the strontium titanate fine particles (A) and the strontium titanate fine particles (B) can be confirmed by observation under a scanning electron microscope (SEM).

Incidentally, in a case in which plural kinds of strontium titanate fine particles having different shapes are present in one kind of strontium titanate fine particles, the shape of the most abundant particles (for example, the shape of more than 50 particles among the 100 particles confirmed) is taken as the particle shape as the shape of the strontium titanate fine particles.

In addition, it is preferable that at least either of the strontium titanate fine particles (A) or the strontium titanate fine particles (B) is lanthanum-containing strontium titanate fine particles. The lanthanum-containing strontium titanate fine particles are strontium titanate fine particles doped with lanthanum. By doping strontium titanate fine particles with lanthanum, the electrical resistance of the particle powder decreases and the effect of suppressing excessive electrification at a low temperature and a low humidity is likely to be exerted.

The lanthanum-containing strontium titanate fine particles can be produced using an aqueous solution of lanthanum chloride and the like, for example, as strontium titanate fine particles A9 and B8 are produced in Examples of the present application.

Incidentally, whether or not strontium titanate fine particles contain lanthanum can be confirmed by X-ray fluorescence analysis (XRF). Specifically, the measurement can be conducted by pressurizing and pelletizing 3 g of sample and subjecting the resultant pellet to the measurement by qualitative analysis using an X-ray fluorescence spectrometer “XRF-1700” (manufactured by Shimadzu Corporation). Incidentally, The Kα peak angle of the element measured from the 20 table is determined and used in the measurement.

It is preferable that the contents of the strontium titanate fine particles (A) and the strontium titanate fine particles (B) are such that the contained mass ratio (A)/(B) satisfies the relation of the following Formula (2):

0.5≤(A)/(B)≤2.5. Formula (2):

It is more preferable that the contained mass ratio (A)/(B) further satisfies the relation of the following Formula (3).

0.7≤(A)/(B)≤2.0 Formula (3):

It is easy to set the coverage factor of the surface of the toner base particles by the external additive to a sufficient extent to suppress excessive electrification when the contained mass ratio (A)/(B) of the strontium titanate fine particles (A) to the strontium titanate fine particles (B) is 0.5 or more. In addition, when the contained mass ratio is 2.5 or less, the coverage factor of the surface of the toner base particles by the external additive does not become too great and the low temperature fixability can be maintained.

The external additive may contain one or more kinds of other strontium titanate fine particles different in particle diameter from the strontium titanate fine particles (A) and (B) as long as the effects by the use of the strontium titanate particles (A) and (B) described above are not impaired. The particle diameter of the peak top in the number particle size distribution of such other strontium titanate fine particles is not particularly limited, the particle diameter may be smaller than that of the strontium titanate fine particles (A), larger than that of the strontium titanate fine particles (B), or a particle diameter between those of the strontium titanate fine particles (A) and (B).

The external additive may further contain inorganic fine particles other than the strontium titanate particles, organic fine particles, and a lubricant as long as the effects by the use of the strontium titanate particles (A) and (B) described above are not impaired.

Examples of the inorganic fine particles other than the strontium titanate particles may include silica particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles. The inorganic fine particles may be subjected to a hydrophobization treatment using a known surface treatment agent such as a silane coupling agent or silicone oil if necessary. In addition, the size of the inorganic fine particles is preferably in a range of from 20 to 500 nm and more preferably in a range of from 70 to 300 nm as a number average primary particle diameter.

As the organic fine particles, organic fine particles formed of homopolymers such as styrene and methyl methacrylate and copolymers thereof can be used. The size of the organic fine particles is about from 10 to 2000 nm as a number average primary particle diameter, and the particle shape thereof is, for example, a spherical shape.

The lubricant is used for the purpose of further improving the cleaning property and transcription property. Examples of the lubricant may include metal salts of higher fatty acids, and more specific examples thereof may include zinc, aluminum, copper, magnesium, calcium and the like salts of stearic acid; zinc, manganese, iron, copper, magnesium and the like salts of oleic acid; zinc, copper, magnesium, calcium and the like salts of palmitic acid; zinc, calcium and the like salts of linoleic acid; and zinc, calcium and the like salts of ricinoleic acid.

It is preferable that the total content of the strontium titanate particles in the toner is in a range of 0.1 part by mass or more and 10.0 parts by mass or less with respect to 100 parts by mass of the toner particles. It is preferable that the total amount of the external additives (namely, the total amount of the strontium titanate particles and other external additives) is in the above range in a case in which external additives other than the strontium titanate particles are used.

3. Toner Particles

[Melting Point of Toner Particles]

The melting point (Tm) of the toner particle according to the present embodiment is preferably in a range of from 60° C. to 90° C. and more preferably in a range of from 65° C. to 80° C. It is possible to achieve both sufficient low temperature fixability and heat resistant storability when the melting point is in the above range. In addition, it is also possible to favorable heat resistance (thermal strength) of the toner particles and to achieve sufficient heat resistant storability. The melting point (Tm) can be measured in the same manner as in the crystalline polyester resin described above.

[Particle Diameter of Toner Particle]

The volume median diameter of the toner particles according to the present embodiment is preferably in a range of from 3 to 8 μm and more preferably in a range of from 5 to 8 μm. It is possible to accurately reproduce dots having a high resolution of a 1200 dpi level when the volume median diameter is in the above range. Incidentally, the volume median diameter can be controlled by the concentration of the aggregating agent to be used at the time of production, the amount of the organic solvent added, the fusion time, the composition of the binder resin, and the like.

The volume median diameter can be measured using a measuring instrument connected to a computer system equipped with Multisizer 3 (manufactured by Beckman Coulter, Inc.) and data processing software Software V3.51. Specifically, 0.02 g of sample (toner particles) is added to and mixed with 20 mL of the surfactant solution (for example, a surfactant solution obtained by diluting a neutral detergent containing a surfactant component 10 times with pure water for the purpose of dispersing the toner particles) and then subjected to an ultrasonic dispersion treatment for 1 minute to prepare a dispersion of toner particles. This dispersion of toner particles is injected into a beaker containing ISOTON II (manufactured by Beckman Coulter, Inc.) in the sample stand using a pipette until the concentration thereof displayed on the measuring instrument reaches 8%. By setting the concentration of the dispersion to this concentration, a reproducible measurement value can be attained. Thereafter, the frequency value is calculated when the count number of measured particles is set to 25000, the aperture diameter is set to 100 μm, the range of from 2 to 60 μm which is the measurement range is divided into 256 in the measuring instrument, and the particle diameter at 50% from the larger integrated volume fraction is determined as the volume median diameter.

[Method for Producing Toner Particles]

A method for producing toner particles may include a step of producing toner base particles (hereinafter also referred to as the “toner base particle producing step”) and a step of adding an external additive to the surface of the toner base particles (hereinafter also referred to as the “external additive adding step”). The method for producing toner base particles is not limited, and examples thereof may include known methods such as a kneading pulverization method, a suspension polymerization method, an emulsion aggregation method, a dissolution suspension method, a polyester expanding method, and a dispersion polymerization method.

In addition, the external additive adding step can also be performed before the drying step, but it is preferable to perform the external additive adding step after the toner base particles are subjected to the drying step. The addition of the external additive can be conducted, for example, by mixing the toner base particles with the external additive using various known mixing devices such as a turbulent mixer, a Henschel mixer, a Nauta mixer, and a V type mixer.

[Developer]

It is considered that the toner particles produced as described above are used, for example, as a one-component magnetic toner by containing a magnetic material therein, as a toner as a two-component developer by being mixed with a so-called carrier, and as a nonmagnetic toner singly, but it is preferable that the toner particles is used as a two-component developer.

As the carrier constituting the two-component developer, magnetic particles formed of a conventionally known material such as a metal such as iron, ferrite, or magnetite or an alloy of such a metal with a metal such as aluminum or lead can be used, and it is particularly preferable to use ferrite particles. The volume average particle diameter of the carrier is preferably from 15 to 100 μm and more preferably from 25 to 60 μm.

It is preferable that the carrier is covered with a resin. The resin for covering is not limited, but an olefin resin, a cyclohexyl methacrylate-methyl methacrylate copolymer, a styrene resin, a styrene-acrylic resin, a silicone resin, an ester resin, a fluororesin and the like can be used.

In addition, the carrier can be a so-called resin dispersion type carrier in which magnetic particles are dispersed in a resin. The resin for constituting the resin dispersion type carrier is also not limited, and a known resin can be used, and an acrylic resin, a styrene acrylic resin, a polyester resin, a fluororesin, a phenol resin and the like can be used.

### EXAMPLES

Hereinafter, the present invention will be more specifically described with reference to Examples and Comparative Examples, but the present invention is not limited to the following Examples.

1. Preparation of Amorphous Polyester Resin Fine Particle Dispersion A1

The following raw materials were placed in a three-necked flask heated and dried, the pressure in the vessel was reduced by pressure reduction operation, the atmosphere in the vessel was further set to an inert atmosphere using nitrogen gas, and the raw materials were refluxed at 180° C. for 5 hours under mechanical stirring.

Bisphenol A propylene oxide: 3500 parts by mass

Bisphenol A ethylene oxide: 1400 parts by mass

1,3,5-Benzenetricarboxylic acid: 55 parts by mass

1,2,4-Benzenetricarboxylic acid: 620 parts by mass

Terephthalic acid: 950 parts by mass

Fumaric acid: 410 parts by mass

Dibutyltin oxide: 25 parts by mass

Thereafter, the temperature was gradually raised to 240° C. while the water generated in the reaction system was distilled off under reduced pressure. Furthermore, the dehydration condensation reaction was continuously conducted at 240° C. for 3 hours, and the molecular weight was confirmed by GPC when the reaction mixture was in a viscous state. When the mass average molecular weight reached 42000, the distillation under reduced pressure was stopped, and the reaction was stopped, thereby obtaining Amorphous Polyester Resin al.

Next, 200 parts by mass of Amorphous Polyester Resin al from which insoluble components had been removed, 100 parts by mass of methyl ethyl ketone, 35 parts by mass of isopropyl alcohol, and 7.0 parts by mass of a 10% by mass ammonia aqueous solution were placed in a separable flask and sufficiently mixed together and dissolved, and ion-exchanged water was then added to the solution dropwise at a liquid sending speed of 8 g/min using a liquid feeding pump while heating and stirring the mixture at 40° C. After the solution became uniformly cloudy, the liquid sending speed was increased to 15 g/min to effect phase inversion, and the dropwise addition was stopped when the amount of liquid added reached 580 parts by mass. Thereafter, the solvent was removed under reduced pressure, thereby obtaining Amorphous Polyester Resin Fine Particle Dispersion A1. The volume average particle diameter of the dispersion was measured using Microtrac UPA-150 (manufactured by Nikkiso Co., Ltd.) and found to be 164 nm, and the solid concentration in the resin particles was 35%.

2-1. Preparation of Crystalline Polyester Resin Fine Particle Dispersion C1

(1) Synthesis of Crystalline Polyester Resin c1

The following raw materials were placed in a three-necked flask heated and dried, 0.5 part by mass of dibutyltin oxide as a catalyst was then added thereto.

Dodecanedioic acid: 250 parts by mass

1,9-Nonanediol: 150 parts by mass

Thereafter, the air in the three-necked flask was replaced with nitrogen by pressure reduction operation to have an inert atmosphere, and the raw materials were stirred at 180° C. for 5 hours by mechanical stirring and refluxed so that the reaction proceeded. During the reaction, the water generated in the reaction system was distilled off. Thereafter, the temperature was gradually raised to 230° C. under reduced pressure, the mixture was stirred for 2 hours, and the molecular weight was confirmed by GPC when the reaction mixture was in a viscous state. When the mass average molecular weight reached 24000, and the distillation under reduced pressure was stopped, thereby obtaining Crystalline Polyester Resin c1.

(2) Preparation of Dispersion C1

In a separable flask, 1000 parts by mass of Crystalline Polyester Resin c1, 600 parts by mass of methyl ethyl ketone, and 150 parts by mass of isopropyl alcohol were placed, this was thoroughly mixed and dissolved at 40° C., and 42 parts by mass of a 10% by mass ammonia aqueous solution was then added to the solution dropwise. The heating temperature was raised to 67° C. and ion-exchanged water was added thereto dropwise at a liquid sending speed of 8 g/min using a liquid feeding pump while stirring the mixture. After the solution became uniformly cloudy, the liquid sending speed was increased to 15 g/min, and the dropwise addition of ion-exchanged water was stopped when the total amount of liquid added reached 4000 parts by mass. Thereafter, the solvent was removed under reduced pressure, thereby obtaining Amorphous Polyester Resin Fine Particle Dispersion C1. The volume average particle diameter of the dispersion was measured using Microtrac UPA-150 (manufactured by Nikkiso Co., Ltd.) and found to be 169 nm, and the solid concentration in the resin particles was 25%.

2-2. Preparation of Crystalline Polyester Resin Fine Particle Dispersions C2 to C5

(1) Synthesis of Crystalline Polyester Resins c2 to c5

Crystalline Polyester Resins c2 to c5 were obtained in the same manner as in the preparation of Crystalline Polyester Resin c1 except that the kinds of raw material monomers used in the synthesis of Crystalline Polyester Resin c1 were changed as described in the following Table 1.

TABLE 1

| Crystalline | | |
|---|---|---|
| polyester | | |
| resin | Acid | Alcohol |
| c1 | Dodecanedioic acid (C12) | 1,9-Nonanediol (C9) |
| c2 | Adipic acid (C6) | 1,6-Hexanediol (C6) |
| c3 | Tetradecanedioic acid (C14) | 1,14-Tetradecanediol (C14) |
| c4 | Succinic acid (C4) | 1,4-Butanediol (C4) |
| c5 | Hexadecanedioic acid (C16) | 1,16-Hexadecanediol (C16) |

(2) Preparation of Dispersions C2 to C5

Crystalline Polyester Resin Fine Particle Dispersions C2 to C5 were obtained in the same manner as in the preparation of Crystalline Polyester Resin Fine Particle Dispersion C1 except that Crystalline Polyester Resin c1 was changed to Crystalline Polyester Resins c2 to c5 as described in the following Table 2.

TABLE 2

| Crystalline polyester resin fine | |
|---|---|
| particle dispersion No. | Crystalline polyester resin No. |
| C1 | c1 |
| C2 | c2 |
| C3 | c3 |
| C4 | c4 |
| C5 | c5 |

3. Preparation of Magenta Colorant Fine Particle Dispersion

In 195 parts by mass of deionized water, 5 parts by mass of an anionic surfactant (“NEOGEN RK” manufactured by DKS Co., Ltd.) was mixed and dissolved. Thereto, 50 parts by mass of C. I. Pigment Red 122 (manufactured by Clariant Japan K. K.) was added and dispersed therein for 10 minutes using a homogenizer (“ULTRA TURRAX” manufactured by IKA), thereby obtaining a magenta colorant fine particle dispersion having a solid content (magenta colorant fine particles) of 20% by mass. The volume average particle diameter of the magenta colorant fine particles in the magenta colorant fine particle dispersion obtained was measured using Microtrac UPA-150 (manufactured by Nikkiso Co., Ltd.) and found to be 185 nm.

4. Preparation of Release Agent Fine Particle Dispersion W1

The following raw materials were heated to 110° C. and dispersed using a homogenizer (ULTRA TURRAX T50 manufactured by IKA).

Ester wax WE5 (manufactured by NOF Corporation): 50 parts by mass

Anionic surfactant (“NEOGEN RK” manufactured by DKS Co., Ltd.): 5 parts by mass

Ion-exchanged water: 200 parts by mass

Next, the dispersion was subjected to a dispersion treatment using Manton-Gaulin High Pressure Homogenizer (manufactured by Manton-Gaulin Company), thereby preparing Release Agent Fine Particle Dispersion W1 (releasing agent concentration: 26% by mass) in which a release agent having an average particle diameter of 0.21 μm was dispersed. The volume average particle diameter of the particles in Release Agent Fine Particle Dispersion W1 was measured using Microtrac UPA-150 (manufactured by Nikkiso Co., Ltd.) and found to be 215 nm.

5. Production of Toner Base Particles

[Production of Toner Base Particles 1]

(Aggregation and Fusion Step and Aging Step)

The following raw materials were used.

Crystalline Resin Fine Particle Dispersion C1: 12.8 parts by mass

Amorphous Resin Fine Particle Dispersion A1: 100 parts by mass

Magenta colorant fine particle dispersion: 15.0 parts by mass

Anionic surfactant (20% aqueous solution of Dowfax 2A1): 4.1 parts by mass

Release Agent Fine Particle Dispersion W1: 12 parts by mass

Among the raw materials, Amorphous Resin Fine Particle Dispersion A1, Crystalline Resin Fine Particle Dispersion C1, an anionic surfactant, and 250 parts by mass of ion-exchanged water were placed in a polymerization kettle equipped with a pH meter, a stirring blade, and a thermometer, and the surfactant was mixed with Amorphous Resin Fine Particle Dispersion A1 and Crystalline Resin Fine Particle Dispersion C1 while stirring the mixture at 140 rpm for 15 minutes. The magenta colorant fine particle dispersion and the release agent fine particle dispersion were added to and mixed with this, and then a 0.3 M nitric acid aqueous solution was added to this raw material mixture to adjust the pH to 4.8. Subsequently, 22 parts by mass of a 10% nitric acid aqueous solution of aluminum sulfate as an aggregating agent was added to the raw material mixture dropwise while applying a shearing force at 4000 rpm using ULTRA TURRAX. The viscosity of the raw material mixture rapidly increases during this dropwise addition of aggregating agent, and thus the speed of dropwise addition was decreased at the time point at which the viscosity increased so that the aggregating agent was not biased to one place. When the dropwise addition of aggregating agent was completed, the number of revolutions was further increased to 5000 rpm and the mixture was stirred for 5 minutes so that the aggregating agent and the raw material mixture were thoroughly mixed.

A stirrer and a mantle heater were installed in the reaction vessel, the temperature was raised at a rate of temperature rise of 0.2° C./min up to a temperature of 40° C. and at a rate of temperature rise of 0.05° C./min after the temperature reached 40° C. while adjusting the number of revolutions of the stirrer so that the slurry was sufficiently stirred, and the particle diameter was measured every 10 minutes using Coulter Multisizer 3 (aperture diameter: 100 μm, manufactured by Beckman Coulter, Inc.). The temperature was held when the volume average particle diameter reached 5.2 μm, and a mixed solution in which the following raw materials were mixed in advance and of which the pH was adjusted to 3.8 was added to the slurry over 20 minutes.

Amorphous Polyester Resin Fine Particle Dispersion A1: 55 parts by mass

Ion-exchanged water: 22 parts by mass

Anionic surfactant (20% aqueous solution of Dowfax 2A1): 0.8 part by mass

After the temperature was held at 50° C. for 30 minutes, 0.8 part of 20% EDTA (ethylenediamine tetraacetic acid) solution was added to the reaction vessel, next, a 1 mol/L sodium hydroxide aqueous solution was added thereto to control the pH of the raw material dispersion to 7.5. Thereafter, the temperature was raised to 85° C. at a rate of temperature rise of 1° C./min while adjusting the pH to 7.5 every 5° C., and the temperature was held at 85° C.

(Cooling Step)

The shape factor of the reaction mixture in the reactor was measured using FPIA-3000 (manufactured by Sysmex Corporation), and the reaction mixture was cooled at a rate of temperature fall of 10° C./min when the shape factor reached 0.962, thereby obtaining Toner Base Particle Dispersion 1.

(Filtration and Washing Step and Drying Step)

Toner Base Particle Dispersion 1 was filtered to recover the toner base particles, and the toner base particles were thoroughly washed with ion-exchanged water. Subsequently, the toner base particles were dried at 40° C., thereby obtaining Toner Base Particles 1. The Toner Base Particles 1 thus obtained had a volume average particle diameter of 5.8 μm and an average circularity of 0.963.

[Production of Toner Base Particles 2, 3, 5, and 6]

Toner Base Particles 2, 3, 5, and 6 were obtained in the same manner as in Example 1 except that Crystalline Polyester Resin Fine Particle Dispersions C2 to C5 were respectively used instead of Crystalline

Polyester Resin Fine Particle Dispersion C1 as described in the following Table 4.

[Production of Toner Base Particles 4]

Toner Base Particles 4 were obtained in the same manner as in Example 1 except that the raw materials were changed as follows.

Amorphous Polyester Resin Fine Particle Dispersion (A1): 1160 parts by mass

Crystalline Polyester Resin Fine Particle Dispersion (C1): 0 part by mass

Magenta colorant fine particle dispersion: 209 parts by mass

Anionic surfactant (20% aqueous solution of Dowfax 2A1): 40 parts by mass

Ion-exchanged water: 1500 parts by mass

6. Production of Strontium Titanate Fine Particles

[Preparation of Strontium Titanate Fine Particles A1]

The hydrous titanium oxide slurry obtained by hydrolyzing a titanyl sulfate aqueous solution was washed with an alkali aqueous solution. Next, hydrochloric acid was added to the slurry of hydrous titanium oxide, and the pH was adjusted to 1.0, thereby obtaining a titania sol dispersion. NaOH was added to the titania sol dispersion thus obtained, the pH of the dispersion was adjusted, and washing was repeated until the electric conductivity of the supernatant reached 70 μS/cm, thereby obtaining hydrous titanium oxide.

Sr(OH)₂.8H₂O was added to the hydrous titanium oxide in a molar amount to be 0.99 time that of the hydrous titanium oxide, the mixture was placed in a SUS reaction vessel, and the reaction vessel was purged with nitrogen gas. Furthermore, distilled water was added to the mixture so as to have a concentration of 0.5 mol/L in terms of SrTiO₃. The slurry thus obtained was heated to 80° C. at a rate of 30° C./hour in a nitrogen atmosphere, and the reaction conducted for 5 hours after the temperature reached 80° C. After the reaction, the reaction mixture was cooled to room temperature, the supernatant liquid was removed, and the remaining slurry was then repeatedly washed with pure water. Thereafter, the slurry was added to an aqueous solution in which sodium stearate was dissolved in an amount to be 3% by mass with respect to the solid content of the slurry in a nitrogen atmosphere. While further stirring the mixture, a calcium sulfate aqueous solution was added thereto dropwise to precipitate calcium stearate on the surface of the perovskite type crystal. Thereafter, the slurry was repeatedly washed with pure water and then filtered using Nutsche, and the cake thus obtained was dried, thereby obtaining Strontium Titanate Fine Particles A1 which did not pass through the sintering step and of which the surface was treated with calcium stearate. The shape of Strontium Titanate Fine Particles A1 was observed under SEM, and as a result, Strontium Titanate Fine Particles A1 had rectangular parallelepiped and/or cubic particle shapes. The particle diameter R_{A} of the peak top in the number particle size distribution of Strontium Titanate Fine Particles A1 was 40 nm.

Incidentally, the peak top particle diameter of the strontium titanate fine particles having a cubic or rectangular parallelepiped shape was measured by the following method.

Strontium titanate fine particles were observed at a magnification of 40,000-fold under a scanning electron microscope (SEM) (“JSM-7401F” manufactured by JEOL Ltd.), the longest diameter and shortest diameter of every particle were measured by image analysis of primary particles, and the intermediate value thereof was taken as the sphere equivalent diameter. Thereafter, the number particle size distribution was determined based on the particle diameter and number of the 100 primary particles measured. The particle diameter of the peak top of the peak present in the distribution was taken as the particle diameter of the strontium titanate particles.

[Preparation of Strontium Titanate Fine Particles A2 to A7 and B9]

Perovskite Type Strontium Titanate Fine Particles A2 to A7 and B9 having a cubic or rectangular parallelepiped shape and a particle diameter R_{A} or R_{B} presented in Table 4 were prepared by adjusting the reaction temperature of strontium titanate, the rate of temperature rise to this temperature, the pH of the dispersion after the addition of hydrochloric acid, and the pH of the dispersion after the addition of NaOH as described in the following Table 3 in the preparation of Strontium Titanate Fine Particles A1.

TABLE 3

| | pH of dispersion | | | |
|---|---|---|---|---|
| Strontium | after addition of | | Rate of | |
| titanate | hydrochloric | Reaction | temperature | Reaction |
| particle No. | acid/NaOH | temperature | rise | time |
| A1 | 1.0/5.0 | 80° C. | 30° C./h | 5 h |
| A2 | 0.6/4.6 | 90° C. | 70° C./h | 5 h |
| A3 | 0.8/4.8 | 90° C. | 70° C./h | 5 h |
| A4 | 1.0/5.0 | 90° C. | 70° C./h | 5 h |
| A5 | 0.8/4.8 | 75° C. | 30° C./h | 5 h |
| A6 | 0.7/4.7 | 70° C. | 20° C./h | 5 h |
| A7 | 0.6/4.6 | 70° C. | 20° C./h | 5 h |
| B9 | 0.5/4.5 | 60° C. | 20° C./h | 2 h |

[Preparation of Strontium Titanate Fine Particles A8]

Using a ball mill, 600 g of strontium carbonate and 350 g of titanium oxide were wet mixed for 8 hours, and this mixture was then filtered, dried, and molded at a pressure of 10 kg/cm², and sintered at 1200° C. for 7 hours. This was mechanically pulverized, thereby obtaining Strontium Titanate Fine Particles A8 which had a particle diameter R_{A} of 47 nm and passed through the sintering step. The shape of Strontium Titanate Fine Particles A8 was observed under SEM, and as a result, Strontium Titanate Fine Particles A8 had an irregular shape.

Incidentally, the peak top particle diameter of strontium titanate fine particles having an irregular shape was measured by the following method.

Image photographing of the strontium titanate fine particles was conducted at a magnification of 5000-fold using a scanning electron microscope (SEM). The SEM image thus obtained was binarized using an image processing analyzer (for example, “LUZEX AP” manufactured by NIRECO CORPORATION). Among a plurality of photographs, the Feret diameters of 100 strontium titanate particles along the horizontal direction were calculated, and the particle size distribution was determined based on the Feret diameters along the horizontal direction and the number of strontium titanate particles. The Feret diameter along the horizontal direction of the peak top of the peak present in the distribution was taken as the particle diameter of the strontium titanate particles. Here, the Feret diameter along the horizontal direction was taken as the length of the side parallel to the x axis of the bounding rectangle when the image of the external additive was binarized.

[Preparation of Strontium Titanate Fine Particles B1 to B7]

Strontium Titanate Fine Particles B1 to B7 having an irregular shape and a particle diameter R_{B} presented in Table 4 were prepared by adjusting the pulverization conditions and classification conditions in the preparation of Strontium Titanate Fine Particles A8.

[Preparation of Strontium Titanate Fine Particles A9]

After metatitanic acid obtained by the sulfuric acid method was subjected to a deironization bleaching treatment, a sodium hydroxide aqueous solution was added thereto to adjust the pH to 9.0, and the mixture was subjected to a desulfurization treatment. Thereafter, the resultant was neutralized to pH 5.8 with hydrochloric acid, filtered, and washed with water. Water was added to the washed cake thus obtained to obtain a slurry having a concentration of 1.85 mol/L in terms of TiO₂, then hydrochloric acid was added thereto to adjust the pH to 1.0, the cake was subjected to a peptization treatment, thereby obtaining metatitanic acid. From this metatitanic acid, 1.877 moles of metatitanic acid in terms of TiO₂ was sampled and put in a 3 L reaction vessel. Thereto, 2.159 moles of a strontium chloride solution was added so as to have a Ti molar ratio of 1.15, and 0.216 mole of a lanthanum chloride solution was further added so as to have a Sr molar ratio of 10 mol %, and then the TiO₂ concentration was adjusted to 0.939 mol/L. Next, the mixture was heated to 90° C. while being stirred, then 553 mL of a 10 N sodium hydroxide aqueous solution was added thereto over 1 hour, the mixture was then continuously stirred at 95° C. for 1 hour, and the reaction was terminated.

The reaction slurry was cooled to 50° C., hydrochloric acid was added thereto until the pH reached 5.0, and the mixture was continuously stirred for 1 hour. The precipitate thus obtained was decanted and washed, hydrochloric acid was added to the slurry containing this precipitate, to adjust the pH to 6.5, isobutyltrimethoxysilane at 9% by weight with respect to the solid content was added thereto, and the mixture was continuously stirred and held for 1 hour. Subsequently, the mixture was filtered and washed, and the cake thus obtained was dried in the air at 120° C. for 8 hours, thereby obtaining Lanthanum-Containing Strontium Titanate Fine Particles A9. The Lanthanum-Containing Strontium Titanate Fine Particles A9 thus obtained had a rectangular parallelepiped shape, and the particle diameter R_{A} thereof was calculated by the method described above and found to be 35 nm.

[Preparation of Strontium Titanate Fine Particles B8]

Lanthanum-Containing Strontium Titanate Fine Particles B8 having a particle diameter R_{B} presented in Table 4 were prepared in the same manner as in the preparation of Strontium Titanate Fine Particles A9 except that the amount of TiO₂ sampled from metatitanic acid was changed to 0.357 mole, the amount of strontium chloride solution was changed to 0.410 mole, the lanthanum chloride solution was changed to 0.041 mole, and TiO₂ concentration was changed to 0.179 mol/L.

### EXAMPLE 1

[Production of Toner Particles 1]

To 250 g of Toner Base Particles 1 (volume average particle diameter: 5.8 μm), 0.6 part by mass of hydrophobic silica particles (treated with HMDS, degree of hydrophobicity: 72%, number average primary particle diameter: 20 nm), 0.50 part by mass of Strontium Titanate Fine Particles A1 (R_{A}: 40 nm), and 0.33 part by mass of Strontium Titanate Fine Particles B1 (R_{B}: 1000 nm) were added, and these were mixed together for 20 minutes using a Henschel mixer, thereby producing Toner Particles 1.

### Examples 2 to 25 and Comparative Examples 1 to 5

[Production of Toner Particles 2 to 30]

Toner Particles 2 to 30 were produced in the same manner as in the production of Toner Particles 1 except that the kinds of toner base particles, the kinds of strontium titanate fine particles (A) and (B), and the added ratio (A)/(B) were changed as presented in Table 4 in the production of Toner Particles 1.

The kinds of the crystalline polyester resin contained in Toner Particles 1 to 30 thus produced, the kinds of the strontium titanate fine particles (A) and (B) contained in Toner Particles 1 to 30 thus produced, the particle diameter R_{A} or R_{B}, the particle shape, and the particle diameter difference and contained mass ratio between the strontium titanate fine particles (A) and (B) are summarized in the following Table 4.

TABLE 4

| | | Crystalline polyester resin | | | | | | | | | | |
|---|---|---|---|---|---|---|---|---|---|---|---|---|
| | Toner | | Number of carbon atoms | Strontium titanate fine particles | | | | | | | | |
| Toner | base | | in aliphatic dicarboxylic | (A) | | | (B) | | | Particle diameter | Contained | |
| particle | particle | Dispersion | acid-number of carbon | | R_{A} | | | R_{B} | | differenceR_{B} − R_{A} | mass ratio | |
| No. | No. | No. | atoms in aliphatic diol | Kind | (nm) | Shape | Kind | (nm) | Shape | (nm) | (A)/(B) | Remarks |
| 1 | 1 | C1 | C12-C9 | A1 | 40 | Rectangular parallelepiped | B1 | 1000 | Irregular | 960 | 1.5 | Example 1 |
| 2 | 2 | C2 | C6-C6 | A1 | 40 | Rectangular parallelepiped | B1 | 1000 | Irregular | 960 | 1.5 | Example 2 |
| 3 | 3 | C3 | C14-C14 | A1 | 40 | Rectangular parallelepiped | B1 | 1000 | Irregular | 960 | 1.5 | Example 3 |
| 4 | 1 | C1 | C12-C9 | A9 | 35 | Rectangular parallelepiped | B1 | 1000 | Irregular | 965 | 1.5 | Example 4 |
| | | | | | | (containing La) | | | | | | |
| 5 | 1 | C1 | C12-C9 | A8 | 47 | Irregular | B1 | 1000 | Irregular | 953 | 1.5 | Example 5 |
| 6 | 1 | C1 | C12-C9 | A1 | 40 | Rectangular parallelepiped | B8 | 850 | Rectangular parallelepiped | 810 | 1.5 | Example 6 |
| | | | | | | | | | (containing La) | | | |
| 7 | 1 | C1 | C12-C9 | A9 | 35 | Rectangular parallelepiped | B8 | 850 | Rectangular parallelepiped | 815 | 1.5 | Example 7 |
| | | | | | | (containing La) | | | (containing La) | | | |
| 8 | 1 | C1 | C12-C9 | A1 | 40 | Rectangular parallelepiped | B9 | 950 | Irregular | 910 | 1.5 | Example 8 |
| 9 | 1 | C1 | C12-C9 | A6 | 100 | Rectangular parallelepiped | B2 | 280 | Irregular | 180 | 1.5 | Example 9 |
| 10 | 1 | C1 | C12-C9 | A2 | 8 | Rectangular parallelepiped | B1 | 1000 | Irregular | 992 | 1.5 | Example 10 |
| 11 | 1 | C1 | C12-C9 | A3 | 10 | Rectangular parallelepiped | B1 | 1000 | Irregular | 990 | 1.5 | Example 11 |
| 12 | 1 | C1 | C12-C9 | A4 | 20 | Rectangular parallelepiped | B1 | 1000 | Irregular | 980 | 1.5 | Example 12 |
| 13 | 1 | C1 | C12-C9 | A5 | 60 | Rectangular parallelepiped | B1 | 1000 | Irregular | 940 | 1.5 | Example 13 |
| 14 | 1 | C1 | C12-C9 | A6 | 100 | Rectangular parallelepiped | B1 | 1000 | Irregular | 900 | 1.5 | Example 14 |
| 15 | 1 | C1 | C12-C9 | A7 | 105 | Rectangular parallelepiped | B1 | 1000 | Irregular | 895 | 1.5 | Example 15 |
| 16 | 1 | C1 | C12-C9 | A1 | 40 | Rectangular parallelepiped | B2 | 280 | Irregular | 240 | 1.5 | Example 16 |
| 17 | 1 | C1 | C12-C9 | A1 | 40 | Rectangular parallelepiped | B3 | 300 | Irregular | 260 | 1.5 | Example 17 |
| 18 | 1 | C1 | C12-C9 | A1 | 40 | Rectangular parallelepiped | B4 | 310 | Irregular | 270 | 1.5 | Example 18 |
| 19 | 1 | C1 | C12-C9 | A1 | 40 | Rectangular parallelepiped | B5 | 1500 | Irregular | 1460 | 1.5 | Example 19 |
| 20 | 1 | C1 | C12-C9 | A1 | 40 | Rectangular parallelepiped | B6 | 2000 | Irregular | 1960 | 1.5 | Example 20 |
| 21 | 1 | C1 | C12-C9 | A1 | 40 | Rectangular parallelepiped | B7 | 2500 | Irregular | 2460 | 1.5 | Example 21 |
| 22 | 1 | C1 | C12-C9 | A1 | 40 | Rectangular parallelepiped | B1 | 1000 | Irregular | 960 | 0.3 | Example 22 |
| 23 | 1 | C1 | C12-C9 | A1 | 40 | Rectangular parallelepiped | B1 | 1000 | Irregular | 960 | 0.5 | Example 23 |
| 24 | 1 | C1 | C12-C9 | A1 | 40 | Rectangular parallelepiped | B1 | 1000 | Irregular | 960 | 2.5 | Example 24 |
| 25 | 1 | C1 | C12-C9 | A1 | 40 | Rectangular parallelepiped | B1 | 1000 | Irregular | 960 | 2.9 | Example 25 |
| 26 | 4 | — | — | A1 | 40 | Rectangular parallelepiped | B1 | 1000 | Irregular | 960 | 1.5 | Comparative Example 1 |
| 27 | 5 | C4 | C4-C4 | A1 | 40 | Rectangular parallelepiped | B1 | 1000 | Irregular | 960 | 1.5 | Comparative Example 2 |
| 28 | 6 | C5 | C16-C16 | A1 | 40 | Rectangular parallelepiped | B1 | 1000 | Irregular | 960 | 1.5 | Comparative Example 3 |
| 29 | 1 | C1 | C12-C9 | A1 | 40 | Rectangular parallelepiped | — | — | — | — | — | Comparative Example 4 |
| 30 | 1 | C1 | C12-C9 | — | — | — | B1 | 1000 | Irregular | — | — | Comparative Example 5 |

The low temperature fixability, heat resistance, and electrically charged amount of each of Toner Particles 1 to 30 were evaluated. Incidentally, the low temperature fixability and the electrically charged amount were measured using a developer containing the toner particles. The carrier particles produced by the following method were used in the developer.

<Production of Carrier Particles>

(Production of Core Particles)

The raw materials were weighed so that MnO was 35 mol %, MgO was 14.5 mol %, Fe₂O₃ was 50 mol %, and SrO was 0.5 mol %, mixed with water, and then pulverized using a wet media mill for 5 hours, thereby obtaining a slurry. The slurry obtained was dried using a spray drier, thereby obtaining spherical particles. The particle size of these particles was adjusted, and the particles were then heated at 950° C. for 2 hours and subjected to the preliminary calcination in a rotary kiln. The particles calcined were pulverized with stainless steel beads having a diameter of 0.3 cm using a dry ball mill for 1 hour, PVA as a binder was added thereto in an amount to be 0.8% by mass with respect to the solid content, and water and a dispersing agent were further added thereto, and the mixture was pulverized for 25 hours with zirconia beads having a diameter of 0.5 cm. Subsequently, the particles pulverized were granulated and dried using a spray drier, and subjected to the main calcination by being held in an electric furnace at a temperature of 1050° C. for 20 hours.

Thereafter, the particles were crushed, further classified to adjust the particle size thereof, and the low magnetic force products were then separated therefrom by magnetic separation, thereby obtaining core material particles. The volume average particle diameter of the core material particles was 28.0 μm.

(Preparation of Resin for Covering)

One in which 100 parts by mass of cyclohexyl methacrylate monomer and 1 part by mass of dodecanethiol were mixed and dissolved was subjected to emulsion polymerization in a flask in which 0.5 part by mass of an anionic surfactant “NEOGEN SC” manufactured by DKS Co., Ltd.) was dissolved in 400 parts by mass of ion-exchanged water, and 50 parts by mass of ion-exchanged water in which 0.5 part by mass of ammonium persulfate as an initiator was dissolved was added to this while slowly mixing the mixture for 10 minutes. After the interior of the flask was purged with nitrogen, the flask was heated using an oil bath until the temperature of contents reached 70° C. while stirring the interior thereof, and the emulsion polymerization was continuously conducted as it was for 5 hours, thereby obtaining a resin dispersion. Thereafter, the resin dispersion was dried using a spray drying, thereby obtaining a resin for covering. The weight average molecular weight of the resin for covering was 350,000.

(Preparation of Carrier Particles)

In a high-speed mixer equipped with horizontal impellers, 100 parts by mass of the core material particles prepared above and 4.5 parts by mass of the resin for covering were placed, and mixed and stirred at 22° C. for 15 minutes under the conditions in which the circumferential velocity of the horizontal rotary blade was 8 msec. Thereafter, mixing was conducted at 120° C. for 50 minutes so that the surface of the core material particles was covered with the covering material by the action of mechanical impulsive force (mechanochemical method), and the core material particles were cooled to room temperature, thereby obtaining carrier particles.

<Production of Developer>

Using a V blender, 6 parts by mass of toner particles were mixed with 100 parts by mass of the carrier particles in an environment at normal temperature and normal humidity (temperature: 10° C., relative humidity: 20% RH, temperature: 30° C., relative humidity: 80% RH). The treatment was conducted by setting the number of revolutions of the V blender to 20 rpm and the stirring time to 20 minutes, and the mixture was further sieved using a sieve with an opening of 125 μm, thereby obtaining a developer.

<Low Temperature Fixability>

Using “bizhub PRESS C 1070” (manufactured by Konica Minolta, Inc.) which was a commercially available full-color multifunctional machine as an image forming apparatus, an unfixed solid image (amount of toner attached: 8.0 g/m²) was formed on A4-sized wood free paper “CF Paper” (manufactured by Konica Minolta, Inc.) in an environment at normal temperature and normal humidity (temperature: 20° C., humidity: 50% RH). Next, fixing was conducted by setting the surface temperature of the pressure roller of the fixing apparatus to 100° C. and changing the surface temperature of the heating roller in a range of from 130° C. to 170° C. at a 2° C. increment. The lowest fixing temperature at which the image stain due to the fixing offset was not visually confirmed was taken as the lowest fixing temperature.

Furthermore, the low temperature fixability was evaluated by the lowest fixing temperature based on the following evaluation criteria.

⊙: less than 135° C.

∘: 135° C. or more and less than 140° C.

x: 140° C. or more

Incidentally, ⊙ and ∘ are regarded as practically usable levels. There are problems in practical use when the lowest fixing temperature of the toner is 140° C. or more since it is difficult to sufficiently fix the toner at the target paper feeding speed.

<Heat Resistance>

The toner particles were taken in a 10 mL glass bottle having an inner diameter of 21 mm by 0.5 g, the lid was closed, the glass bottle was shaken 600 times at room temperature using a shaking machine “Tap Denser KYT-2000” (manufactured by SEISHIN EN IERPRISE CO., LTD.). Thereafter, the glass bottle was left to stand for 2 hours in an environment at a temperature of 55° C. and a humidity of 35% RH in a state in which the lid was opened. Subsequently, the toner particles were carefully placed on a sieve having 48 meshes (opening: 350 μm) so as not to crush the aggregate of toner particles, and the sieve was set in the “Powder Tester” (manufactured by HOSOKAWA MICRON CORPORATION) and immobilized with a pressing bar and a knob nut. The vibration intensity was adjusted so as to have a feed width of 1 mm, vibration was applied to the sieve for 10 seconds, then the ratio (% by mass) of the amount of toner remaining on the sieve was measured, and the toner aggregation rate was calculated by the following Formula (A).

toner aggregation rate (%)=(mass of toner remaining on sieve (g))/0.5 (g)×100) Formula (A):

The same measurement was conducted at temperatures of 57.5° C. and 60° C., respectively, and the results were plotted so that the X axis represented the temperature and the Y axis represented the toner aggregation rate. An approximate straight line was drawn between two temperatures sandwiching the region in which the toner aggregation rate reached 50% among the temperatures of 55° C., 57.5° C., and 60° C., the temperature at which the toner aggregation rate reached 50% was calculated by interpolation, and this temperature was taken as the heat resistant temperature.

Furthermore, the heat resistance was evaluated by the heat resistant temperature based on the following evaluation criteria.

⊙: 59° C. or more

∘: 58° C. or more and less than 59° C.

x: less than 58° C.

Incidentally, ⊙ and ∘ are regarded as practically usable levels.

<Electrically Charged Amount>

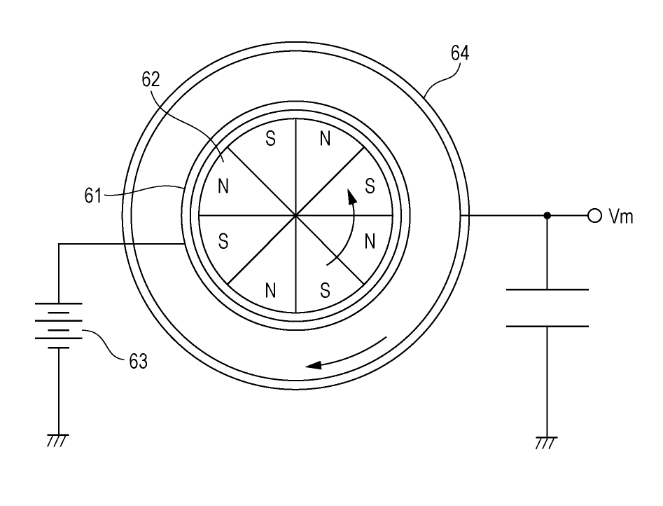

The electrically charged amount of the developer was measured using the apparatus illustrated in FIG. 1. First, 1 g of the developer weighed using a precision balance was placed on the entire surface of an electrically conductive sleeve 61 so as to be uniform. The number of revolutions of a magnet roll 62 provided in the electrically conductive sleeve 61 was set to 1000 rpm as well as a voltage of 2 kV was supplied from a bias supply 63 to the electrically conductive sleeve 61. In this state, the developer was left to stand for 30 seconds, and the toner particles were collected on a cylindrical electrode 64. After 30 seconds, the electrically charged amount of the toner particles was determined as well as the electric potential Vm of the cylindrical electrode 64 was read. Furthermore, the mass of the toner particles collected was measured using a precision balance, and the average electrically charged amount (μC/g) was determined.

The electrically charged property was evaluated by the average electrically charged amount based on the following evaluation criteria.

⊙: 40 μC/g or more and less than 48 μC/g

∘: 48 μC/g or more and less than 55 μC/g

x: 55 μC/g or more

Incidentally, ⊙ and ∘ are regarded as practically usable levels.

The evaluation results for Toner Particles 1 to 30 are summarized in the following Table 5.

TABLE 5

| | Evaluation | | |
|---|---|---|---|
| | Low temperature | | Average |
| Toner | fixability | Heat | electrically charged |
| particle No. | (° C.) | resistance (° C.) | amount [−μC/g] |
| 1 | 131.5 (⊙) | 60.5 (⊙) | 42.9 (⊙) |
| 2 | 128.4 (⊙) | 59.1 (⊙) | 40.5 (⊙) |
| 3 | 134.8 (⊙) | 61.2 (⊙) | 45.6 (⊙) |
| 4 | 131.7 (⊙) | 60.6 (⊙) | 41.0 (⊙) |
| 5 | 131.0 (⊙) | 60.3 (⊙) | 47.4 (⊙) |
| 6 | 130.8 (⊙) | 60.3 (⊙) | 45.7 (⊙) |
| 7 | 130.7 (⊙) | 60.4 (⊙) | 44.0 (⊙) |
| 8 | 130.5 (⊙) | 60.2 (⊙) | 46.5 (⊙) |
| 9 | 135.8 (◯) | 61.0 (⊙) | 42.0 (⊙) |
| 10 | 136.5 (◯) | 61.5 (⊙) | 41.8 (⊙) |
| 11 | 134.7 (⊙) | 61.3 (⊙) | 42.5 (⊙) |
| 12 | 133.4 (⊙) | 60.7 (⊙) | 43.4 (⊙) |
| 13 | 130.1 (⊙) | 59.8 (⊙) | 44.5 (⊙) |
| 14 | 128.1 (⊙) | 59.4 (⊙) | 45.8 (⊙) |
| 15 | 126.9 (⊙) | 58.9 (◯) | 48.9 (◯) |
| 16 | 136.1 (◯) | 61.3 (⊙) | 41.5 (⊙) |
| 17 | 135.4 (◯) | 61.2 (⊙) | 42.2 (⊙) |
| 18 | 133.9 (⊙) | 60.9 (⊙) | 42.6 (⊙) |
| 19 | 129.8 (⊙) | 59.5 (⊙) | 44.9 (⊙) |
| 20 | 127.4 (⊙) | 59.0 (⊙) | 45.7 (⊙) |
| 21 | 124.8 (⊙) | 58.7 (◯) | 48.7 (◯) |
| 22 | 130.1 (⊙) | 59.7 (⊙) | 48.5 (◯) |
| 23 | 129.4 (⊙) | 59.4 (⊙) | 45.8 (⊙) |
| 24 | 134.6 (⊙) | 61.2 (⊙) | 41.9 (⊙) |
| 25 | 136.1 (◯) | 61.4 (⊙) | 40.9 (⊙) |
| 26 | 145 (X) | 63.1 (⊙) | 44.2 (⊙) |
| 27 | 126.1 (⊙) | 56.5 (X) | 41.5 (⊙) |
| 28 | 142.3 (X) | 62.2 (⊙) | 56.1 (X) |
| 29 | 141 (X) | 61.9 (⊙) | 40.8 (⊙) |
| 30 | 128.4 (⊙) | 58.8 (◯) | 56.7 (X) |

As is apparent from the results of Table 5, Toner Particles 1 to 25 containing toner base particles containing a crystalline polyester resin which is a polycondensate of an aliphatic dicarboxylic acid having from 6 to 14 carbon atoms and an aliphatic diol having from 6 to 14 carbon atoms and the strontium titanate fine particles (A) and strontium titanate fine particles (B) having different particle diameters from each other were all toner particles which exhibited both low temperature fixability and heat resistance and of which excessive electrification was suppressed. For example, in Toner Particles 1 in which particularly the particle diameter difference between the particle diameter R_{A} of the strontium titanate fine particles (A) and the particle diameter R_{B} of the strontium titanate fine particles (B) was 200 nm or more, the low temperature fixability was improved as compared with Toner Particles 9 in which the particle diameter difference was less than 200 nm. It is considered that this is because the coverage factor by the strontium titanate fine particles is properly decreased as the particle diameter of the strontium titanate fine particles (B) is relatively large.

In addition, in Toner Particles 11 to 14 in which the particle diameter R_{A} of the strontium titanate fine particles (A) was in a range of 10 nm or more and 100 nm or less, the low temperature fixability was improved as compared with Toner Particles 10 in which the particle diameter R_{A} of the strontium titanate fine particles (A) was less than 10 nm. In addition, the heat resistance and electrically charged rate were improved as compared with Toner Particles 15 in which the particle diameter R_{A} was more than 100 nm. It is considered that the coverage factor by the strontium titanate fine particles increases and the low temperature fixability slightly deteriorates when R_{A} is less than 10 nm but the coverage factor by the strontium titanate fine particles decreases and the heat resistance and electrically charged rate slightly decrease when R_{A} is more than 100 nm.

In Toner Particles 18 to 20 in which the particle diameter R_{B} of the strontium titanate fine particles (B) was in a range of more than 300 nm and 2000 nm or less, the low temperature fixability was improved as compared with Toner Particles 16 and 17 in which the particle diameter R_{B} of the strontium titanate fine particles (B) was 300 nm or less. In addition, the heat resistance and the electrically charged rate were improved as compared with Toner Particles 21 in which the particle diameter R_{B} was more than 2,000 nm. It is considered that the coverage factor by the strontium titanate fine particles increases and the low temperature fixability slightly deteriorates when R_{B} is less than 300 nm but the coverage factor by the strontium titanate fine particles decreases and the heat resistance and electrically charged rate slightly decrease when R_{B} is more than 2000 nm.

In Toner Particles 1 in which the strontium titanate fine particles (A) have a rectangular parallelepiped shape, the average electrically charged amount slightly decreased and the electrically charged property was improved as compared with Toner Particles 5 in which the strontium titanate fine particles (A) and (B) both have an irregular shape. It is considered that this is because the contact area between the strontium titanate fine particles and the toner base particles increases and the desorption of the strontium titanate fine particles from the toner base particles is suppressed, and the effect of decreasing the electrically charged amount is more likely to be exerted as the particle shape of one of the strontium titanate fine particles (A) or (B) is a rectangular parallelepiped shape and the particle shape of the other is an irregular shape. In addition, in Toner Particles 4 in which the strontium titanate fine particles (A) were lanthanum-containing fine particles having a rectangular parallelepiped shape, the average electrically charged amount further decreased and the electrically charged property was improved as compared with Toner Particles 1 in which the strontium titanate fine particles (A) which did not contain lanthanum were used. It is considered that this is because the electrical resistance of the particle powder decreases and the effect of suppressing excessive electrification at a low temperature and a low humidity is likely to be exerted as the strontium titanate fine particles are doped with lanthanum. However, in Toner Particles 6 in which the strontium titanate fine particles (A) have a rectangular parallelepiped shape and the strontium titanate fine particles (B) are lanthanum-containing fine particles having a rectangular parallelepiped shape and Toner Particles 7 in which both the strontium titanate fine particles (A) and (B) are lanthanum-containing fine particles having a rectangular parallelepiped shape, the average electrically charged amount was slightly lower than that of Toner Particles 5 but the average electrically charged amount was slightly higher than those of Toner Particles 1 and 4. It is considered that this is because part of the effect obtained by doping the strontium titanate fine particles with lanthanum was canceled out by the disadvantage due to the use of two kinds of particles having a rectangular parallelepiped shape.

In Toner Particles 23 and 24 in which the contained mass ratio (A)/(B) of the strontium titanate fine particles (A) to the strontium titanate fine particles (B) was in a range of 0.5 or more and 2.5 or less, the electrically charged property was improved as compared with Toner Particles 22 in which the contained mass ratio was less than 0.5. In addition, the low temperature fixability was improved as compared with Toner Particles 25 in which the contained mass ratio was more than 2.5. It is considered that the relative amount of the strontium titanate fine particles (A) is small (and the amount of the strontium titanate fine particles (B) is great) when the contained mass ratio is less than 0.5, and thus the coverage factor by the strontium titanate fine particles decreases and the electrically charged rate slightly decreases. On the other hand, it is considered that the relative amount of the strontium titanate fine particles (A) is great (and the amount of the strontium titanate fine particles (B) is small) when the contained mass ratio is more than 2.5, and thus the coverage factor by the strontium titanate fine particles increases and the low temperature fixability slightly deteriorates.

Meanwhile, Toner Particles 26 in which the toner base particles did not contain the crystalline polyester resin exhibited poor low temperature fixability. In addition, Toner Particles 27 in which the aliphatic dicarboxylic acid and aliphatic diol constituting the crystalline polyester resin contained in the toner base particles had less than 6 carbon atoms exhibited low heat resistance, and Toner Particles 28 in which the aliphatic dicarboxylic acid and aliphatic diol constituting the crystalline polyester resin had more than 14 carbon atoms exhibited poor low temperature fixability and electrically charged property. These results indicate that the heat resistance of the toner greatly deteriorates in some cases when the number of carbon atoms in the crystalline polyester resin is too small and the molecular weight increases high when the number of carbon atoms is too large, and thus low temperature fixability deteriorates and further excessive electrification may occur.

Toner Particles 29 containing only the strontium titanate fine particles (A) having a smaller particle diameter as strontium titanate fine particles exhibited poor low temperature fixability. It is considered that this is because the coverage factor by the external additive increases too high when the toner base particles are covered only with the strontium titanate fine particles (A) having a smaller particle diameter and thus heat is not transmitted to the center of the toner particles. On the other hand, Toner Particles 30 containing only the strontium titanate fine particles (B) having a larger particle diameter as strontium titanate fine particles had a great average electrically charged amount. It is considered that this is because the toner base particles are not sufficiently covered only with the strontium titanate fine particles (B) having a larger particle diameter and thus it is not possible to decrease the electrically charged rate.

According to an embodiment of the present invention, it is possible to provide a toner for electrostatic charge image development which exhibits both low temperature fixability and heat resistance and of which excessive electrification is suppressed. Consequently, according to an embodiment of the present invention, further speeding up, high performance, labor saving, and diversification of recording medium in the electrophotographic image forming apparatus are expected and further diffusion of the image forming apparatus is expected.

Although embodiments of the present invention have been described and illustrated in detail, the disclosed embodiments are made for purposes of illustration and example only and not limitation. The scope of the present invention should be interpreted by terms of the appended claims.

What is claimed is:

1. A toner for electrostatic charge image development comprising:
a toner base particle containing a binder resin; and
an external additive containing a strontium titanate fine particle, wherein
the binder resin contains an amorphous resin and a crystalline polyester resin, in which the crystalline polyester resin is a polycondensate of an aliphatic dicarboxylic acid having from 6 to 14 carbon atoms and an aliphatic diol having from 6 to 14 carbon atoms, and
the strontium titanate fine particle contains a strontium titanate fine particle (A) and a strontium titanate fine particle (B), in which a particle diameter R_{A} of a peak top in number particle size distribution of the strontium titanate fine particle (A) is smaller than a particle diameter R_{B} of a peak top in number particle size distribution of the strontium titanate fine particle (B).

2. The toner for electrostatic charge image development according to claim 1, wherein the particle diameter R_{A} of the strontium titanate fine particle (A) and the particle diameter R_{B} of the strontium titanate fine particle (B) satisfy relation of the following Formula (1):
200 nm≤(R_{B}−R_{A})≤3000 nm. Formula (1):

3. The toner for electrostatic charge image development according to claim 1, wherein the particle diameter R_{A} of the strontium titanate fine particle (A) is 10 nm or more and 100 nm or less.

4. The toner for electrostatic charge image development according to claim 3, wherein the particle diameter R_{A} of the strontium titanate fine particle (A) is 20 nm or more and 60 nm or less.

5. The toner for electrostatic charge image development according to claim 1, wherein the particle diameter R_{B} of the strontium titanate fine particle (B) is more than 300 nm and 2000 nm or less.

6. The toner for electrostatic charge image development according to claim 5, wherein the particle diameter R_{B} of the strontium titanate fine particle (B) is 310 nm or more and 1500 nm or less.

7. The toner for electrostatic charge image development according to claim 1, wherein contents of the strontium titanate fine particle (A) and the strontium titanate fine particle (B) are such that a contained mass ratio (A)/(B) satisfies relation of the following Formula (2):
0.5≤(A)/(B)≤2.5. Formula (2):

8. The toner for electrostatic charge image development according to claim 1, wherein either of the strontium titanate fine particle (A) or the strontium titanate fine particle (B) contains a fine particle having a cubic shape and/or a rectangular parallelepiped shape.

9. The toner for electrostatic charge image development according to claim 1, wherein at least either of the strontium titanate fine particle (A) or the strontium titanate fine particle (B) is a lanthanum-containing strontium titanate fine particle.
